(19) United States
(12) Patent Application Publication
(10) Pub. No.: US 2023/0007866 A1
(43) Pub. Date: Jan. 12, 2023

(54) HYDROPONIC SYSTEM

(71) Applicant: MARY AGROTECHNOLOGIES INC., Markham (CA)

(72) Inventor: Chuhan Qin, Richmond Hill (CA)

(21) Appl. No.: 17/784,664

(22) PCT Filed: Dec. 18, 2020
(86) PCT No.: PCT/CA2020/051760

§ 371 Date: Jun. 12, 2022

Related U.S. Application Data
(60) Provisional application No. 62/951,009, filed on Dec. 20, 2019.

(51) Int. Cl. A01G 31/02; A01G 9/24

(52) U.S. Cl. CPC A01G 31/02; A01G 9/247; A01G 9/249

(57) ABSTRACT

The present invention relates to a hydroponic system including an enclosure, the enclosure comprising a top, a bottom, and a plurality of sides defining an interior, the interior containing within one or more plants. The hydroponic system further includes a plurality of lights, comprising a light located on the top, and at least two lights, each of the at least two lights located on at least two sides, wherein all the lights are positioned to illuminate the plants within the enclosure. The hydroponic system may further include a light controller, a water system, a fan system, and a sensor system. The hydroponic system may be controlled via an enclosure-mounted control panel or via a remote interface coupled to a remote user device.

### FIELD OF THE INVENTION

The present specification relates generally to hydroponics, and, in particular, to a single unit hydroponic system with multidirectional interior lighting.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

Hydroponics is a method of growing plants without soil using nutrient-enriched water-based solutions. As hydroponic growing requires less water than soil-based growing, it has enjoyed an increase in popularity in urban and other environment with space restrictions.

However, existing hydroponic systems are very energy intensive, and control and dispersal of waste heat presents an ongoing challenge. Additionally, adequate lighting to all areas of the plant may be difficult to obtain depending on the type of plant and the structure of the hydroponic system.

Therefore, it would be desirable to have a hydroponics system which provides both some improvements over the current state of the art as well as possibly mitigating some of the disadvantages currently known in the art.

Accordingly, there remains a need for improvements in the art.

### SUMMARY OF THE INVENTION

In accordance with an aspect of the invention, there is provided a single unit hydroponic system with multidirectional lighting.

According to an embodiment of the invention, there is provided a hydroponic system including an enclosure, the enclosure comprising a top, a bottom, and a plurality of sides defining an interior, the interior containing within one or more plants; a plurality of lights, comprising a light located on the top, and at least two lights, each of the at least two lights located on at least two sides, wherein all the lights are positioned to illuminate the plants within the enclosure; a light controller, the light controller coupled to the lights and the light controller operative to provide control over one or more operating parameters for each of the lights, the parameters comprising one or more of: activation (on/off), intensity, color spectrum and color temperature; a water system, the water system comprising a water pump and a water storage reservoir, the water system operative to provide water to the one or more plants; a fan system, the fan system operative to circulate air within the enclosure; and a sensor system comprising one or more sensors operative to monitor operating parameters of the hydroponics system, the operating parameters comprising one or more of: temperature, humidity, air flow, light intensity and light color.

The system may further comprise a timing system coupled to the light controller, the timer system operative to activate the light controller according to programmable parameters, the programmable parameters comprising one or more of: duration, light intensity, light color, and time.

The system may further comprise a control panel mounted on the enclosure, the control panel comprising a user interface operative to provide user control of the hydroponic system. Alternatively, or additionally, the system may further comprise a remote interface, the remote interface operative to connect to a remote user device to permit user control over hydroponics system via the remote user device. The 5 remote interface may further comprise a push communications system to send communications to the remote user device.

The system may still further comprise one or more exterior panels within one or more of the sides of the enclosure, the panels comprising an LCD coating to control the opacity of the panels.

The system may still further comprise an external display located on the exterior of the enclosure and coupled to the sensor system, the external display operative to display data from the sensor system. Alternatively, where provided, the remote interface may provide communication of sensor data, enabling the display of the sensor data on the remote user device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

Reference will now be made to the accompanying drawings which show, by way of example only, embodiments of the invention, and how they may be carried into effect, and in which:

FIG. 1 is a front perspective view of a hydroponic system according to an embodiment;

FIG. 2A is a cut-away view showing the back interior of FIG. 1;

FIG. 2B is a cut-away view showing the front interior of FIG. 1;

FIG. 3 is an internal view of a top panel of the hydroponic system of FIG. 1

FIG. 4 is an internal view of a bottom panel of the hydroponic system of FIG. 1; and

FIG. 5 is a block diagram of a control system for the hydroponic system of FIG. 1 according to an embodiment.

### DETAILED DESCRIPTION OF THE EMBODIMENTS

The present invention relates to generally to hydroponics, and, in particular, to a single unit hydroponic system with multidirectional lighting.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

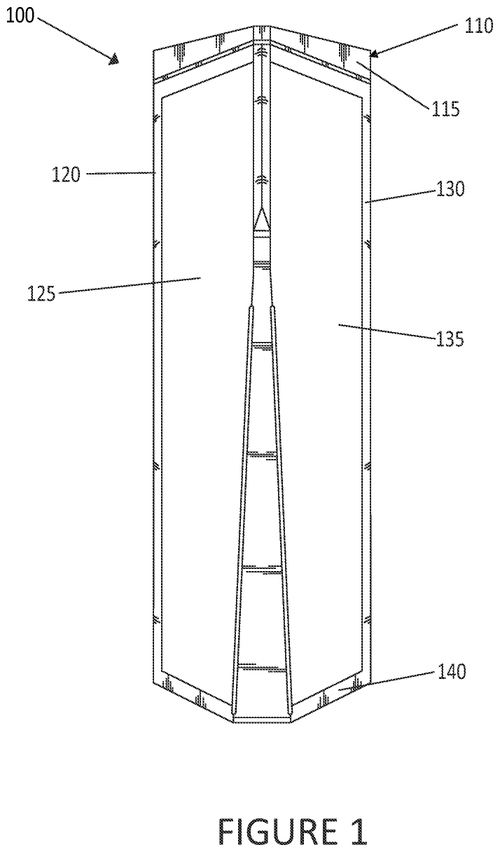

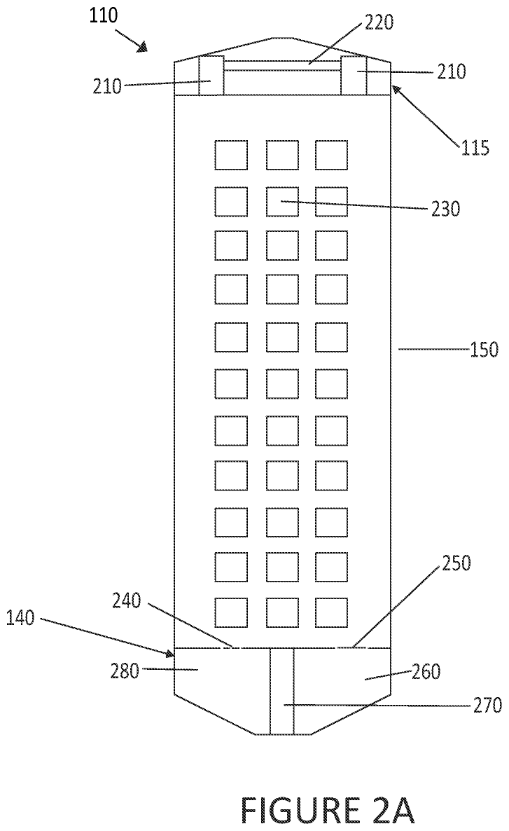

According to an embodiment as shown in FIG. 1, a hydroponic system 100 is comprised of an enclosure 110 to house one or more plants (not shown) which are grown within the enclosure 110. The enclosure 110 is formed with a top 115, sides 120 and 130 and bottom 140. As shown, enclosure 110 is generally triangular, with a third side (shown in FIG. 2) defining a generally triangular prism shape for the enclosure, with the front face having a flattened surface to provide a location to mount lights as described below. Alternate shapes, such a rectangular prism with 4 sides, or an even greater number of sides may be used, and side edges may be flattened if required. One or more of sides 120 and 130 may further incorporate semi-opaque or opaque panels 125 and 135 to control external light penetration to the interior. In some embodiments, panels 125 and 135 may be LCD coated to permit the opacity of the panels to be modified, either manually or automatically. The opacity control may be adjusted to provide natural light and to view the plants within the enclosure (e.g. for inspection or showcase purposes) without the need to open the enclosure. In embodiments with 4 or more sides, any or all of the sides may be provided with a viewing panel as described above, as desired.

Referring to FIGS. 2A and 2B, providing cut-away views showing the back and front, respectively, of enclosure 110, located internally within the top 115 of the system 100, one or more air conditioning units and/or fans 210 control air temperature and air flow through the interior. A heat sink 220 allows for heat to escape via a thermal connection to the exterior of the unit without ventilating additional air. A light 230 mounted on rear side 150 provides directional light targeted to the plants in the interior of the enclosure 110 and is preferably a controllable set of LED chips or equivalent. Additional lights 230 may be mounted on the facing side (not shown) to provide directional lighting throughout the enclosure 110. Again, where there are four or more sides, lights may be mounted on several sides as desired, however, at least one is required to illuminate the plants, and at least two are preferred for greater control over the lighting within the enclosure.

At the bottom 140 of the system, water reservoir 260 is provided along with an access port 250 to permit the addition of water and nutrients and other additives to the water. Water level may be monitored via a float and water sensor 270. One embodiment of the float and sensor is a floatable ball (e.g. sized as a ping-pong ball) and a directed laser to determine the height of the ball. The base further includes an air pump 280 which circulates air into the interior through a vent 240, which may be removable to allow access for cleaning and repair.

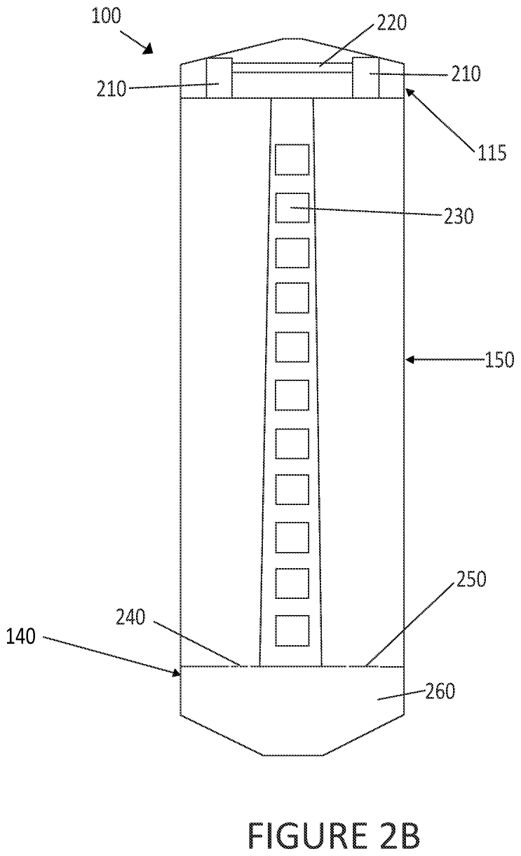

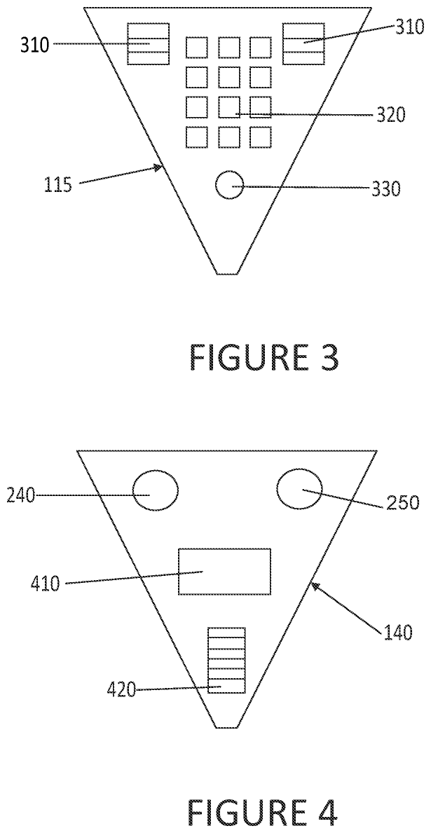

FIG. 3 shows the top 115 of the system 100 as viewed from the interior. The top may include one or more vents 310 to allow airflow through the air conditioning units, along with a top light 320, similarly designed to light 230 (see FIG. 2) to provide targeted light to the plants in the interior. A growth sensor 330 may also be provided to track the growth of plants within the enclosure 110 using ultrasound or similar methods. The base of the system is shown in FIG. 4, again as viewed from the interior. Vent 240 allows for air flow and access port 250 provide access to the interior of the base as discussed above. A planter 410 provides a base for supporting the plants being grown inside the system. A display 420 may also be provided in the base to allow for monitoring of conditions. Alternatively, display 420 may be located on the exterior of enclosure 110, either on the top 115 or bottom 140.

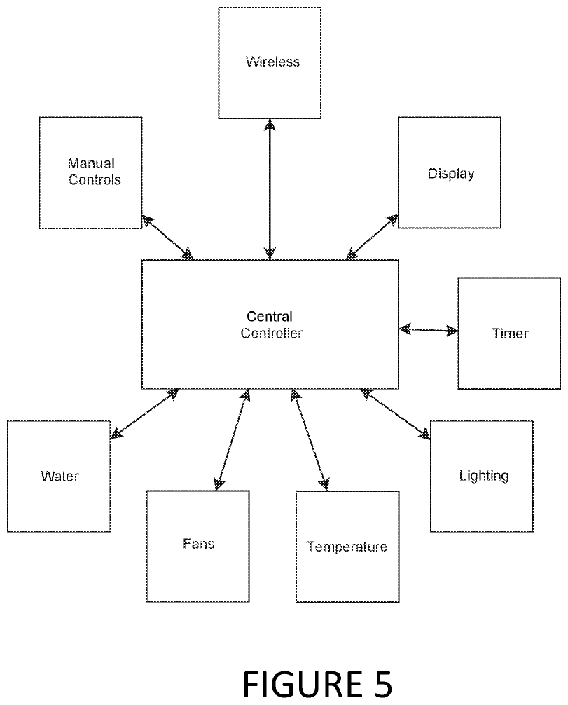

FIG. 5 illustrates a block diagram of the control system for the hydroponic system. A central controller operates via either manual controls on the enclosure 110, or remotely via wireless connectivity to a remote user device, either a dedicated device (remote) or an application-based general user device (phone, tablet). A display may be provided, as discussed above, or information may be sent through the wireless connection and displayed on the user device. The central controller then controls and monitors the light controller, water system, fan system, sensor system and any other controllable elements within the system (e.g. timers). Additionally, the central controller may be programmable to allow for automatic adjustments in operating conditions based on the desired plant growth, with conditions being communicated via wireless for remote alerts and adjustments.

### Lighting System

Internally, as discussed above, lights are mounted as the top light 320, and one or more side lights 230 in the interior of the enclosure to provide multi-directional lighting within the interior targeted at the plants for growth. The lights are preferably LED chips to minimize heat output and provide maximum electrical efficiency. The use of LED chips may further provide a range of intensities and color spectrums to accommodate various types of plant growth within the hydroponic system, considering factors such as the type of plant and the growth stages of the plants. The operating parameters for the lights (e.g. on/off, brightness/intensity, color or color temperature) may be controlled by a light controller coupled to the central controller as discussed above. The light controller may be programmable to allow for automatic timed adjustments (e.g. day/night cycling), with options to manually adjust or override the settings.

The same light controller may be used to control the opacity of the panels 125, 135, or a second light controller may be used.

### Water System

As discussed above, water is stored in water reservoir 260 in the base of the system, with a float and water sensor 270 to measure the water level as discussed above. Preferably, the water sensor 270 produces an alarm signal sent to the central controller to indicate low water level. A temperature sensor may also be present to monitor the temperature of the water. Water filling may be provided through an access port 250 on the interior or exterior of the system. Similarly, a port may be provided, or the same port used, for the addition of nutrients or other additives to the water. A water pump (not shown) ensures regular circulation of water and nutrients to the plants within the system. The water sensor and temperature sensors are preferably monitored through the central controller, to allow for adjustments in other systems to be made in response to changes in water level and temperature. Additional sensors may be provided, such as pH sensors and particle sensors, to track the nutrient level and other parameters of the water.

### Temperature Control

Considering the system 100 as a whole, heat is primarily generated from the lights, and with the airflow driven from the base, along with the natural tendency of warmer air to rise, heat exchange (cooling) to the exterior of the system is provide by one or more air conditioning units 210 located at the top of the system. Heat sinks 220 may also be provided as shown to allow the air conditioning units 210 to be in thermal exchange with the exterior without the need to exchange the air from the interior of the unit, reducing the possibility of contamination and odor from the plant(s) inside the unit.

### Fan System and Power

As discussed above, the air pump 280 for the system 100 is located in the base, driving air up past the plants to the top 115 of the system, where it is cooled and naturally flows back to the bottom. Additionally, the primary power supply may be provided within the base with a connector to an external power source. Alternatively, the power supply may be located externally and coupled to a power input located in the base. The power supply may be driven by standard mains (e.g. 110/120V) power, as available, and may further be provided with and operate off of a battery backup (internal or external), if desired.

Preferably, the operating components are selected (e.g. LED chips for lighting, power supply) to minimize the overall electricity consumption and heat production, and, consequently, to facilitate control over related factors, such as temperature.

### Timer

A timing system may be provided and controlled via the central controller. As discussed, the timing system may primarily be used for scheduling of lighting adjustments such as day/night cycles and color changes. The timing system may further be applied to other functions such as nutrient inputs, internal/external alarms (e.g. water level) and user reminders.

### Other Features

The system 100 may contain additional feature elements not shown as are known in the art. As one example, various air and water filters may be incorporated at key points to ensure quality and allow for replacement as needed. External displays may be provided to allow for on-site visual inspection in addition to remote monitoring. Panels 125 and 135 may be formed from transparent glass or plastic in place of semi-opaque or opaque panels.

As discussed above, the overall structure of the enclosure as shown is a triangular prism with a flattened front edge to permit the installation of lights 230, however, the overall shape may be modified according to space requirements and aesthetic preference. Other shapes such as rectangular prisms, cylinders, and pyramids are contemplated as options, with suitable adjustments in the position and number of lights.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

1. A hydroponic system, comprising:
an enclosure, the enclosure comprising a top, a bottom, and a plurality of sides defining an interior, the interior containing one or more plants within;
a plurality of lights, comprising a light located on the top, and at least two lights, each of the at least two lights located on at least two sides, wherein all the lights are positioned to illuminate the plants within the enclosure;
a light controller, the light controller coupled to the lights and the light controller operative to provide control over one or more operating parameters for each of the lights, the parameters comprising one or more of: activation (on/off), intensity, color spectrum and color temperature;
a water system, the water system comprising a water pump and a water reservoir, the water system operative to provide water to the one or more plants;
a fan system, the fan system operative to circulate air within the enclosure; and
a sensor system comprising one or more sensors operative to monitor operating parameters of the hydroponic system, the operating parameters comprising one or more of: temperature, humidity, airflow, light intensity and light color.

2. The hydroponic system of claim 1, further comprising a timing system coupled to the light controller, the timer system operative to activate the light controller according to programmable parameters, the programmable parameters comprising one or more of: light activation (on/off), light intensity, light color, and time.

3. The hydroponic system of claim 2, further comprising a control panel mounted on the enclosure, the control panel comprising a user interface operative to provide user control of the hydroponic system.

4. The hydroponic system of claim 2, further comprising a remote interface, the remote interface operative to connect to a remote user device to permit user control over the hydroponic system via the remote user device.

5. The hydroponic system of claim 4, wherein the remote interface further comprises a push communications system to send communications to the remote user device.

6. The hydroponic system of claim 1, wherein the water system further comprises a water level sensor coupled to the sensor system, the water level sensor operative to indicate water level within the water reservoir.

7. The hydroponic system of claim 1, further comprising one or more exterior panels within one or more of the sides of the enclosure, the panels comprising an LCD coating to control opacity of the panels.

8. The hydroponic system of claim 6, wherein the panels are coupled to the light controller.

9. The hydroponic system of claim 6, wherein the panels are coupled to a second light controller.

10. The hydroponic system of claim 1, further comprising an external display located on an exterior of the enclosure and coupled to the sensor system, the external display operative to display data from the sensor system.

11. The hydroponic system of claim 3, wherein the control panel further comprises an external display located on an exterior of the enclosure and coupled to the sensor system, the external display operative to display data from the sensor system.

12. The hydroponic system of claim 4, wherein the remote interface further provides communication of sensor data, enabling a display of the sensor data on the remote user device.

13. The hydroponic system of claim 1, wherein the lights are comprised of a plurality of LED chips.

14. The hydroponic system of claim 13, wherein the plurality of LED chips comprises more than one type of LED chip.

15. The hydroponic system of claim 1, wherein the sensor system further comprises one or more of: a plant height sensor and a water nutrient sensor.
